(19) United States
(12) Patent Application Publication
(10) Pub. No.: US 2008/0142170 A1
(43) Pub. Date: Jun. 19, 2008

(54) Vertical blind fashions sleeves

(76) Inventor: Elaine Killian, Mira Loma, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/002,223

(22) Filed: Dec. 13, 2007

Related U.S. Application Data
(60) Provisional application No. 60/874,479, filed on Dec. 13, 2006.

(51) Int. Cl. E06B 9/24

(52) U.S. Cl. 160/236

(57) ABSTRACT

A sleeve covering for vertical blinds is presented where the sleeve is fabricated in an elongated method and is made available on a roll. The pattern on the sleeves can be the same, related to subsequent sleeves or allow for staggering of the printed pattern. The pattern can also repeat after a finite number of sleeves. The consumer slips the end of the sleeve onto a vane of the vertical blind. The sleeve is secured to the top of the blind and the end of the sleeve is trimmed. The consumer continues this process for the remaining sleeves. The sleeves are fabricated from a variety of materials including paper, film, natural or synthetic fibers. The pattern is seasonal; theme based, and is easily changeable. The sleeve also provides additional insulation and light filtering properties.

### CROSS REFERENCE TO RELATED APPLICATION

This application claims the benefit of Provisional 60/874,479 filed Dec. 13, 2006, YEAR the entire contents of which is hereby expressly incorporated by reference herein.

### DESCRIPTION

### Field of the Invention

This invention relates to improvements in treatment for vertical blinds. More particularly, the present improvement consists of an elongated roll of tubular sleeve material with a pre-printed pattern on the roll. The consumer slips the end of the sleeve onto a vane of the vertical blind. The sleeve is secured to the top of the blind and the end of the sleeve is trimmed. The consumer continues this process for the remaining sleeves.

### BACKGROUND OF THE INVENTION

Most vertical blinds are manufactured from fabric, plastic, metal, wood or a combination thereof materials. These blinds provide a fixed appearance because the outside facing surfaces do not change. Some vertical blinds have inserts that provide a different appearance on each side of the vane, but beyond the two sides, there is limited variation. Some patents have been issued on products that cover the vanes with a sock having a pattern. Exemplary examples of these patents are described herein.

U.S. Pat. No. 4,911,220 issued Mar. 27, 1990 to Kevin L. Hiller discloses a replaceable decorative louver covering system. The louver covers are pre-printed where each cover has a pre-printed pattern that is visible where the collective group of covers is installed over all the louvers. While these covers provide the basic function of covering a vertical blind, they are not fabricated from a continuous roll, they do not allow for an alterable cosmetic patter and the pattern is not repeated or repeatable on the blinds.

U.S. Pat. No. 5,303,760 issued Apr. 19, 1994 to Joe A. Perez discloses a blind covering apparatus and method for changing décor on vertical window blinds. This patent provides for a covering of vertical blinds and further provides for decoding information to ensure that the installer places each blind cover in the correct order on the blinds. While this patent provides for a covering for blinds, the coverings are not fabricated from a continuous roll, they do not allow for an alterable cosmetic patter and the pattern is not repeated or repeatable on the blinds.

U.S. Pat. No. 6,510,806 issued Jan. 28, 2003 to Christina Krieck discloses a covering for blinds where the covering is formed as a sleeve that is drawn over the louver or as a flat sheet that is folded over the blind. The blind covering provides no significant pattern and the material exists as either individual tube of material or individual sheets of material. The covers are not fabricated from a single continuous roll, they do not allow for an alterable cosmetic patter and there is no pattern or a pattern to repeat on the blinds.

What is needed is a vertical blind treatment system where the treatment system is a roll of pre-printed or printable material. Material is removed from the roll and brought over each louver. The unused material is trimmed from the roll, and the roll is then used with the next and the remainder of the louvers. The presented application provides this solution making it easy for an installer to quickly install the covers and change them based upon the season or their desire. The vertical blind covering is an easy economic solution to add or change the designs or colors on vertical blinds.

### BRIEF SUMMARY OF THE INVENTION

It is an object of the slip on design for vertical blind window coverings is to provide the material in a roll form. The roll includes sufficient material for covering a plurality of lengths of vertical blind louvers. The consumer would measure the length of one vane and count how many vanes in their vertical blind. They would then multiply the length times the quantity to calculate the total number of feet needed for the window they would like to accessorize. The consumer would slip the end of the sleeve up the vane from the bottom to the top. Once the sleeve is attached securely at the top of the vane, the consumer would then cut the sleeve along the bottom edge of the vane. The installer would then move to the next vane until all sleeves are attached.

It is another object of the slip on design for vertical blind window coverings to provide a pattern that repeats, is different on each side, or where the pattern on each sleeve represents a complete pattern.

It is another object of the slip on design for vertical blind window coverings is to provide a pattern that requires two or more sleeves to provide a visual non-repeating pattern. The pattern can be repeatable to provide for an apparent infinite pattern or image. The sleeves may all have a fixed pattern that the installer can stagger to create a unique pattern.

It is another object of the slip on design for vertical blind window coverings is to provide a temporary attachment mechanism for securing each sleeve on the top of each vane. The attachment mechanism consists of clips, holes, Velcro, buttons, pins or other similar mechanisms to provide for securing the sleeve that are not destructively installable or removable so the sleeves can be re-installed at a future time.

It is another object of the slip on design for vertical blind window coverings is to provide for blank tubular material can be sold without a pattern and a consumer can print and transfer a custom image on one or a plurality of sleeves. One type of custom printing is advertising for a company. The user can print one or more sheets of the image on paper or film and transfer the image to the sleeves by iron-on transfer, sublimation, or adhesion.

It is another object of the slip on design for vertical blind window coverings is to provide some filtering of light, heat and or sound. These properties naturally occur in some materials, but can be incorporated by creating the sleeves in a multi-layers configuration.

It is another object of the slip on design for vertical blind window coverings is to provide theme-based images that are seasonal, artistic, celebratory, designer, licensed images or holiday related. The image can also be printed using 3-D images that are viewed with special glasses.

It is still another object of the slip on design for vertical blind window coverings is to provide the covering made from different natural, synthetic, woven, manmade, materials or a combination thereof.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIGS. 1A-1D shows the installation process of the slip on cover for blinds.

FIG. 2 shows the slip on cover for blinds with a fixed pattern.

FIG. 3 shows the slip on cover for blinds with user alterable pattern.

FIG. 4 shows the slip on cover for blinds with a different pattern on each side of the blind.

FIG. 5 shows a repeating pattern on a slip on cover for vertical blinds.

### DETAILED DESCRIPTION

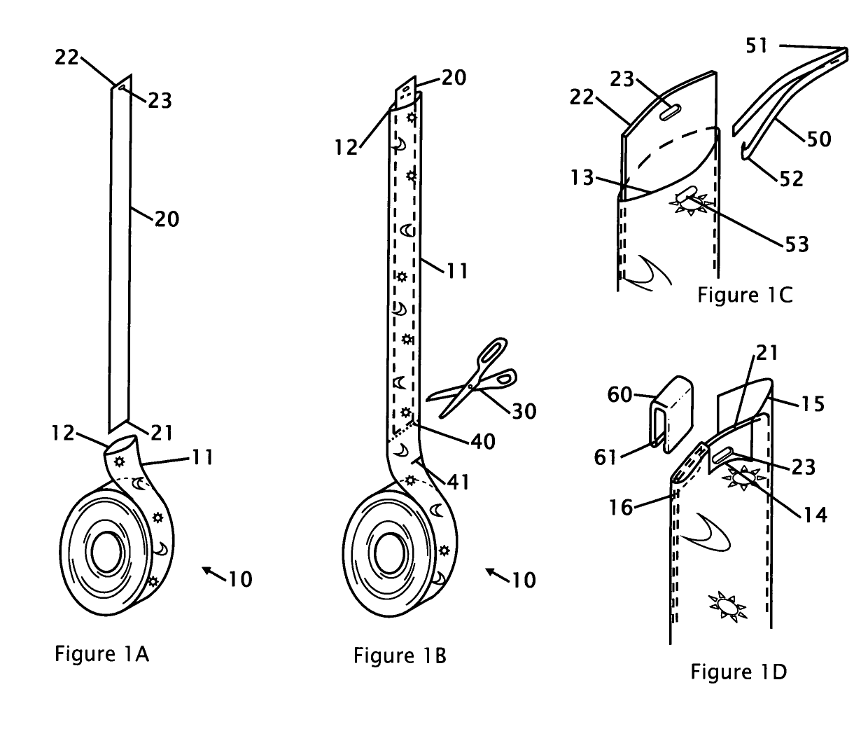

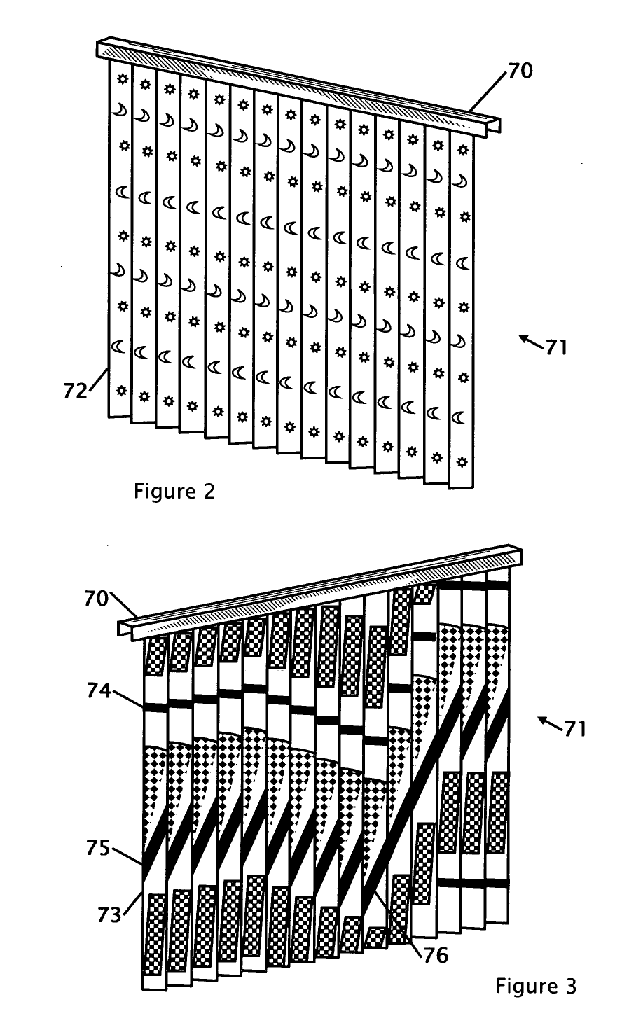

FIGS. 1A-1D shows the installation process of the slip on cover for blinds. Vertical blinds 20 tend to have a slight concave shape to provide some structural strength over their elongated length. They also have the same general width of 3.5 inches. The standard height of the blinds is as long as 120 inches with even longer blinds being possible. Because of the variation in the length of the blind(s) the preferred embodiment of the cover is in a roll 10. The rolls are available in lengths of 15-100 yards with a preferred length of 25 yards. A standard sliding glass door is 6 or 8 feet in width. Vertical blinds for covering a 6-foot door would require approximately 24 vales or 144 yards of fabric. A similar 8-foot door would have 32 vanes and require 192 yards of material.

The designs are purchased in a sleeve roll of material. The sleeve may be made from any number of materials, including but not limited to film of any type such as but not limited to PVC, ABS, polypropylene, paper and any kind of woven material such as but not limited to cotton or synthetic and reeds. The designs are printed in any form on the sleeve. In the case of natural materials such as reeds, as in basket weaves, the material may remain unprinted. The rolls have stock designs with custom designs being available from the manufacturer. Contemplated designs include but are not limited to seasonal such as summer, fall, winter, spring, holidays such as, Halloween, thanksgiving, baby room designs, color designs that could be mixed and matched by alternating two or three vanes in different colors, flower designs, music room designs, kitchen designs, designer designs, Happy Birthday. Custom designs could include but not limited to a specific view such as ocean scene, winter scene, English or Italian garden scene, or running horses, or a specific picture chosen by the consumer. Custom designs could also include advertising or promotion for a company, Disney® characters, cartoon characters, book or comic book characters, pet pictures, baby pictures, etc. In some cases, pictures may be in 3-D to be viewed with 3-D glasses. Custom designs could possibly have one design facing inside the house with another design or color visible from the outside of the house. In another embodiment, the sleeve is a printable material that a user can print on the elongated roll with a standard desktop printer. It is also contemplated that a user can go to a decorating or home improvement store with a photograph, logo or custom image and design the blinds for printing and delivery on the roll(s).

From FIG. 1A, the roll of vain covering 10 is provided in a tubular condition having an opening 12 where on the free end 11 of the roll 10. In the preferred embodiment, the vanes can remain installed on the valance while the cover is slipped over each vane. The vertical blind vane 20 has a top end 22 that attaches to the track in the valance of the blinds where it is retained with a hole or slot 23. Upon installation, the open end of the blind cover 12 is slid onto the end of the vane or louver 21. Material is drawn off the roll and lifted up the blind as shown in FIG. 1B where the end of the blind cover 12 is at, near, or beyond the end of the blind vane 20. After the end of the fabric sleeve is in the desired position, the fabric sleeve is cut 30 from the roll.

The end is usually cut at the bottom of the vane 40, but it is contemplated that the installer could cut the fabric at a location longer or short than the end of the vane. The fabric is cut longer to allow extra material to secure the cover at the top of the blind, or to provide greater apparent length to the blind. In some blind cover sleeves, the pattern repeats at a pre-defined interval such as is commonly found with wallpaper. When there is a repeating pattern, some material will be removed from the end of the roll 41 to ensure that the pattern repeats as desired. It is contemplated that the edge of the pattern include dimensional markings, indicia or indexing marking to ensure that the pattern is duplicated and started from the same or the desired position. Examples of repeating patterns are shown and described in more detail with FIGS. 2, 3 and 4. Various methods are contemplated for securing the blind cover on the vane.

In FIG. 1C, the end of the sleeve is retained on the vane with a clip. In this embodiment, the end of the fabric sleeve 13 is brought up near the end of the vane 22 and below the connection hole 23. This installation is typically performed when the vane is not removed from the valance. The clip has curvature 50 that matches the curvature of the vane. A bent end 51 of the clip provide clearance for the vane and fabric, while the end opposing the bent end has a loop that captures, clips and retains the free portion of the clip 52 to retain the sleeve on the vane. The clip is equally usable to retain the fabric sleeve on the top of the vane as well as securing the end of the fabric on the bottom on the vane (not shown). In another embodiment the sleeve has a hole 53 located where pattern begins and the user can use the existing blind retention mechanism to secure the sleeve to the blind and track. Another contemplated retaining method is shown and described in FIG. 1D.

In figure, 1D the vane is typically removed from the valance to provide access to the retention area at the end 21 of the vane. In this embodiment, the fabric from the blind cover is brought past the end of the blind 15 and the some of the center portion 14 of the fabric is removed to provide access to the slot 23 that retains the blind on the valance. It is also contemplated that the center portion 14 is removed when the sleeve is fabricated to provide a marking for the beginning of the pattern. The excess material on the end of the fabric tube 15 is folded or tucked over the end of the blind 16. A clip 60 is slid over or along the end of the fabric covered blind to retain the sleeve on the end of the blind. The clip has narrowing teeth 61 to improve retention of the clip on the blind and provide a better pinch of the fabric. A second clip is optionally placed on the side opposite the elongated slip, as well as on the lower end 21 (FIG. 1A) of the vane. The clip can be fabricated with one or more magnets within the clip 60. The magnets provide increased retention of the sleeve on the blink without degradation from heat or age that can occur with plastic clips.

Other retention means are of securing the sleeves include but are not limited to adhesive strips or a hole punched in the sleeve at the top to hook the sleeve over the existing blind hook or in the existing hole or slot 23.

FIG. 2 shows the slip on cover for blinds with a fixed pattern. This pattern of blind covering 71 is a repeated pattern 72 of the sun and moon. The multiple covered blinds are placed on the valence 70. The pattern is duplicated and is consistent on all the blinds. Each blind sleeve is placed at approximately the same location on each blind, and minimal variation exists from one blind to the next. It is contemplated that the edge of the pattern include dimensional markings or indexing marking to ensure that the pattern is duplicated and started from the same or the desired position.

FIG. 3 shows the slip on cover for blinds with user alterable pattern. Each individual vane 73 of the blinds 71 are retained on a valance 70. In this embodiment, the pattern on the blind cover includes horizontal line(s) 74, angled line(s) 75 and a combination of other shapes. It is further shown in this figure, that some of the pattern on adjoining vanes is repeated in the same relationship making line(s) 74 appear as a horizontal line. When the pattern is shifted, angled line 76 appears as a continuous line rising with each successive vane.

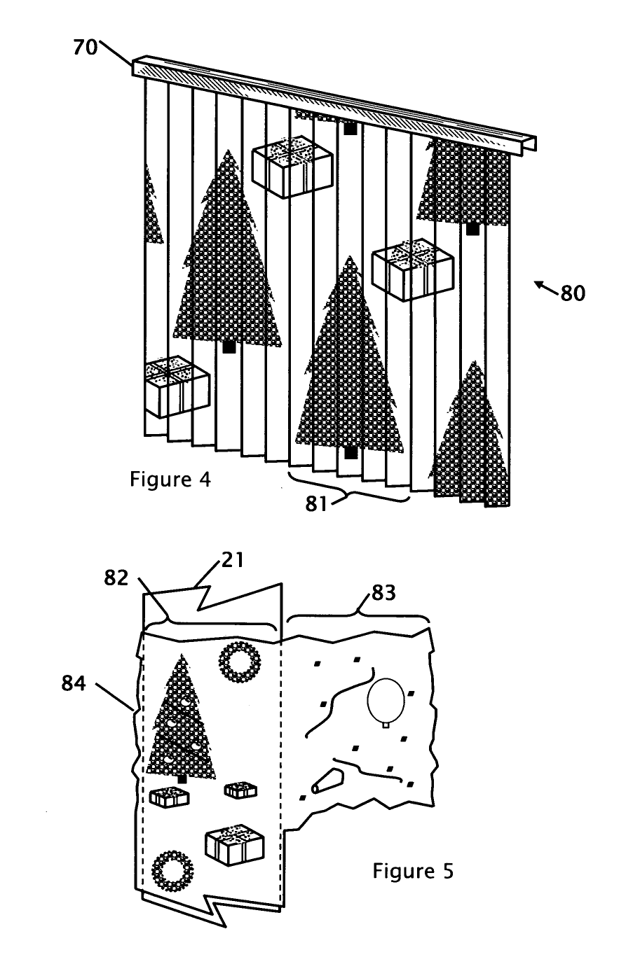

FIG. 4 shows a repeating pattern on a slip on cover for vertical blinds. The blinds 80 are attached to valance 70. These blind covers have a pattern that repeats every five vanes 81. The repeating pattern provides the appearance of a continuous image that appears to repeat infinitely. While the pattern is shown repeating every five blinds it is contemplated that the pattern could repeat with as few as two blind to 20 or more blinds depending upon the image being shown. It is further contemplated that some or all of the pattern can be user created. As an example, if the image was for a birthday celebration, the blind covers are made available with party decorations and the blind covers are provided with a variety of letters that are iron-on (sublimation) transferred or adhesively secured to the blind cover. Various other methods of securing the custom marking also include marking pens, paints or similar permanent or temporary marking systems. It is further contemplated that in the case of custom designs the sleeves would be pre-cut for the consumers specific window size and marked with numbers or letters starting from left or right.

FIG. 5 shows the slip on cover for blinds 80 with a different pattern on each side of the blind. A portion of the sleeve is shown torn away at 84 to allow the image to be unwrapped from the vane. This embodiment is shown partially unwrapped from the vane 21. This is particularly useful when holidays are closely related in dates. As an example, one side of the sleeve has Christmas decorations 82, while the other side has New Year decorations 83. These two particular holidays are only separated by a one-week period, and to minimize the time and effort to cover the blind twice in a short period the two-sided cover is disclosed. The user simply rotates the vanes to expose the desired side. It is contemplated that the vertical blind window coverings provide enhanced filtering of light, heat and or sound. These properties naturally occur in some materials, but can be incorporated by creating the sleeves in a multi-layers configuration.

It is further contemplated that the sleeves are removable and re-usable at a future time. They can also be washed and re-installed using conventional methods and the methods disclosed herein.

Thus, specific embodiments of a slip on design for vertical blind window coverings have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A slip on covering for vertical blinds comprising:
An elongated sleeve having a printed image on the length of the sleeve;
the sleeve is configured having a tubular body having defined front and back surfaces;
the elongated sleeve is provided in a roll format where the front and back surfaces have printed images and is horizontally dividable such that the printed image that covers a plurality of vertical louvers;
the elongated sleeve further has a plurality of indicia to indicate the image starting or repeating position on the sleeve

2. The slip on covering for vertical blinds according to claim 1 wherein the pattern on each side is different image.

3. The slip on covering for vertical blinds according to claim 1 wherein the image is a seasonal for summer, fall, winter or spring.

4. The slip on covering for vertical blinds according to claim 1 wherein the image is a holiday or event of Halloween, thanksgiving or baby.

5. The slip on covering for vertical blinds according to claim 1 wherein at least one side of the elongated sleeves is creased or pleated with a stitched seam to retain the edges of the sleeve with the edges of the vertical louvers.

6. The slip on covering for vertical blinds according to claim 1 wherein the elongated sleeve further includes dimensional markings or indexing marking to ensure that the pattern is duplicated and started from the same or a desired position.

7. The slip on covering for vertical blinds according to claim 6 that further includes numbered or lettered indicia to indicate sequential or ordered placement of each horizontally divided length from the roll.

8. The slip on covering for vertical blinds according to claim 1 wherein the elongated sleeve includes a plurality of pre-cut holes along the elongated roll that indicate the end or pattern start for dividing the length of the roll.

9. The slip on covering for vertical blinds according to claim 8 wherein pre-cut holes match an attachment position on the vertical louvers or elongated ears that straddle the attachment position on the vertical louvers.

10. The slip on covering for vertical blinds according to claim 1 that further includes securing means for securing the end of the elongated sleeve on the end of a vertical louver where the securing means in a magnetic clip located on opposing sides of the elongated sleeve and the vertical louver.

11. A printable slip on covering for vertical blinds comprising:
an elongated sleeve having at least one printable surface;
the sleeve is configured having a tubular body having defined front and back surfaces;
the elongated sleeve is provided in a roll format where the front and back surfaces are printable with an elongated image that is horizontally dividable such that the printed image is dividable to cover a plurality of vertical louvers;
a user configures and prints a desired image based upon the length and number of louvers,
the desired image includes indicia to indicate the image starting or repeating position on the printed sleeve.

12. The printable slip on covering for vertical blinds according to claim 11 wherein the elongated sleeve is printable with a different image on each side.

13. The printable slip on covering for vertical blinds according to claim 11 wherein the image is a seasonal for summer, fall, winter or spring.

14. The printable slip on covering for vertical blinds according to claim 11 wherein the image is a holiday or event of Halloween, thanksgiving or baby.

15. The printable slip on covering for vertical blinds according to claim 11 wherein at least one side of the elongated sleeves is creased or pleated with a stitched seam to retain the edges of the sleeve with the edges of the vertical louvers.

16. The printable slip on covering for vertical blinds according to claim 11 wherein the indicia indicates sequential or ordered placement of each horizontally divided length from the roll.

17. The printable slip on covering for vertical blinds according to claim 11 wherein the elongated sleeve includes a plurality of pre-cut holes along the elongated roll that indicate the end or pattern start or printing start for dividing the length of the roll.

18. The printable slip on covering for vertical blinds according to claim 18 wherein pre-cut holes match an attachment position on the vertical louvers or elongated ears that straddle the attachment position on the vertical louvers.

19. The printable slip on covering for vertical blinds according to claim 11 that further includes securing means for securing the end of the elongated sleeve on the end of a vertical louver where the securing means in a magnetic clip located on opposing sides of the elongated sleeve and the vertical blind.

20. The printable slip on covering for vertical blinds according to claim 11 that further includes curved securing means for securing the end of the elongated sleeve on the end of a vertical louver where the curved securing means is installed on both ends of the vertical louver to match the curvature of the vertical louver.
